(19) United States
(12) Patent Application Publication
(10) Pub. No.: US 2008/0183518 A1
(43) Pub. Date: Jul. 31, 2008

(54) Method and system for analyzing patent flow

(76) Inventors: Herb Jiang, Sinjhuan City (TW); Jen-Diann Chiou, Taipei City (TW); Jerry Tang, Taipei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/699,846

(22) Filed: Jan. 30, 2007

(51) Int. Cl. G06F 19/00

(52) U.S. Cl. 705/7

(57) ABSTRACT

A method for analyzing patent flow. The method comprises: receiving a company set including an entity name; retrieving assignment data for the entity name, where the assignment data includes at least one assignment record having an assignor, an assignee, and a patent identifier associated with the assigner and the assignee, and where the entity name matches either the assignor or the assignee; storing the retrieved assignment data; and graphically displaying the relationship between each retrieved assignor and assignee in the assignment data.

### FIELD OF THE INVENTION

The method and system disclosed relate to the field of patent analysis, and more specifically, a system for and method of analyzing the flow of patent data among entities.

### BACKGROUND

Patent databases, such as those provided by the U.S.P.T.O. and the E.P.O, provide assignment data for patents and published patent applications. This assignment data includes the names of the assignors and the assignees. If provided with the name of an entity, these databases can retrieve all instances of assignments where the entity appears as the assignor or as the assignee. However, these databases provide only rudimentary retrieval with no analysis. For example, theses databases do not provide for illustrating the flow of patent to or from a set of entities.

The present invention addresses the above problems and is directed to achieving at least one of the above stated goals.

### SUMMARY

A method for analyzing patent flow is provided. The method includes receiving a company set including an entity name. The method retrieves assignment data for the entity name. The assignment data includes at least one assignment record having an assignor, an assignee, and a patent identifier associated with the assigner and the assignee. Assignment data is retrieved where the entity name matches either the assignor or the assignee. The method stores the retrieved assignment data, and graphically displays the relationship between each retrieved assignor and assignee in the assignment data.

In accordance with a further embodiment, a system for analyzing patent flow is provided. The system comprises a memory and a processor coupled to the memory. The processor is operable to: retrieve assignment data for the entity name. The assignment data includes at least one assignment record having an assignor, an assignee, and a patent identifier associated with the assigner and the assignee. Assignment data is retrieved where the entity name matches either the assignor or the assignee. The system stores the retrieved assignment data, and graphically displays the relationship between each retrieved assignor and assignee in the assignment data.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the principles of the invention and, together with the description, serve to explain the principles of the invention.

FIG. 1 is a flow-chart of a method of analyzing patent flow consistent with the present invention.

FIG. 2 is a flow-chart of a method of retrieving assignment data consistent with the present invention.

FIGS. 3a-c illustrate graphical displays of assignment data consistent with the present invention.

FIG. 4 is a block diagram of a patent flow platform consistent with the present invention.

### DESCRIPTION

A patent analysis platform is described herein. The patent analysis platform analyzing the flow of patents and published patent applications between assignors and assignees. By receiving the names of one or more entities, the patent analysis platform may retrieve each assignment record from an assignment database where the entity was an assignor or an assignee of one or more patents or published patent applications. The retrieved assignment records may be used to graphically display, for example in a table, the flow of patents and published patent applications between entities. Thus, the table may yield information on what entities are buying patents, or, for example, what entities are selling patents. The table may also illustrate, for example, what entities are innovators.

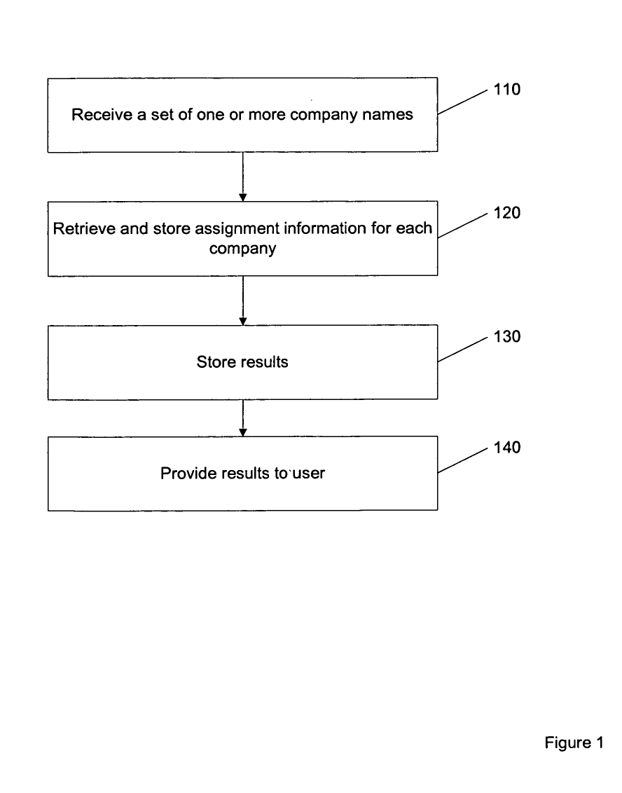

FIG. 1 is a flow-chart of a method of analyzing patent flow consistent with the present invention. A set of one or more company names is received (stage 110). The company names may include, for example, the names of one or more entities. Entities may include all forms of business entities, government corporations, educational and research institutitions, or names of individuals.

For each entity in the set of company names, assignment data is retrieved from one or more assignment databases (stage 120). The assignment data may include one or more assignment records having an assignor, an assignee, and a patent identifier, where the assignor and the assignee are associated with the patent identifier. The patent identifier may be a patent number in the case of a patent or a publication number in the case of a published patent application. The assignment record is retrieved if the entity matches either the assignee or the assignor. In addition, the assignment record may include, for example reel and frame number for the assignment and the date of the assignment. For any given patent identifier, multiple assignment records may be retrieved.

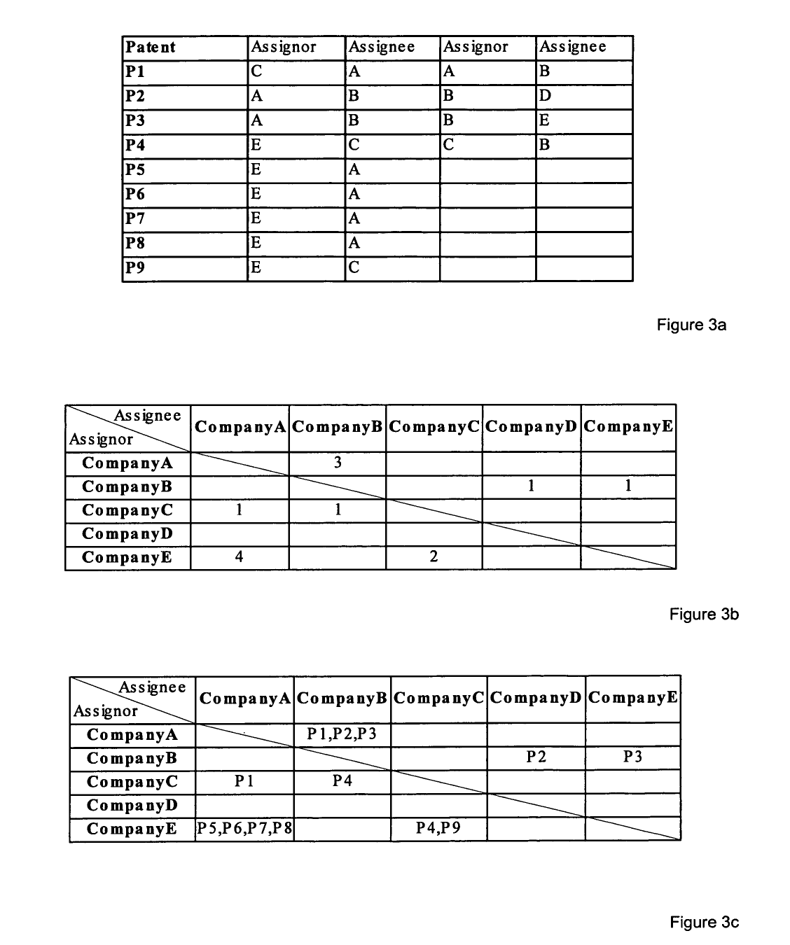

When the assignment records are retrieved, they may be stored in a retrieved patent database (stage 130). In addition, patent data may be retrieved from a patent database and also stored. The patent data may include, for example, the title, abstract, inventors, filing date, publication date, and issue date. Following retrieval and storage of the assignment records, the results may be graphically displayed to a user. (stage 140). For example, the results may be displayed in a table showing, for example, the number of assignments from each assignor to each assignee or the patent identifiers transferred from each assignor to each assignee. In addition, the table may be limited to assignment records for patents matching one or more patent classifications. Thus, specifically patent flow for entities limited to certain technical fields may be displayed. FIGS. 3a-c illustrate examples of the graphical displays.

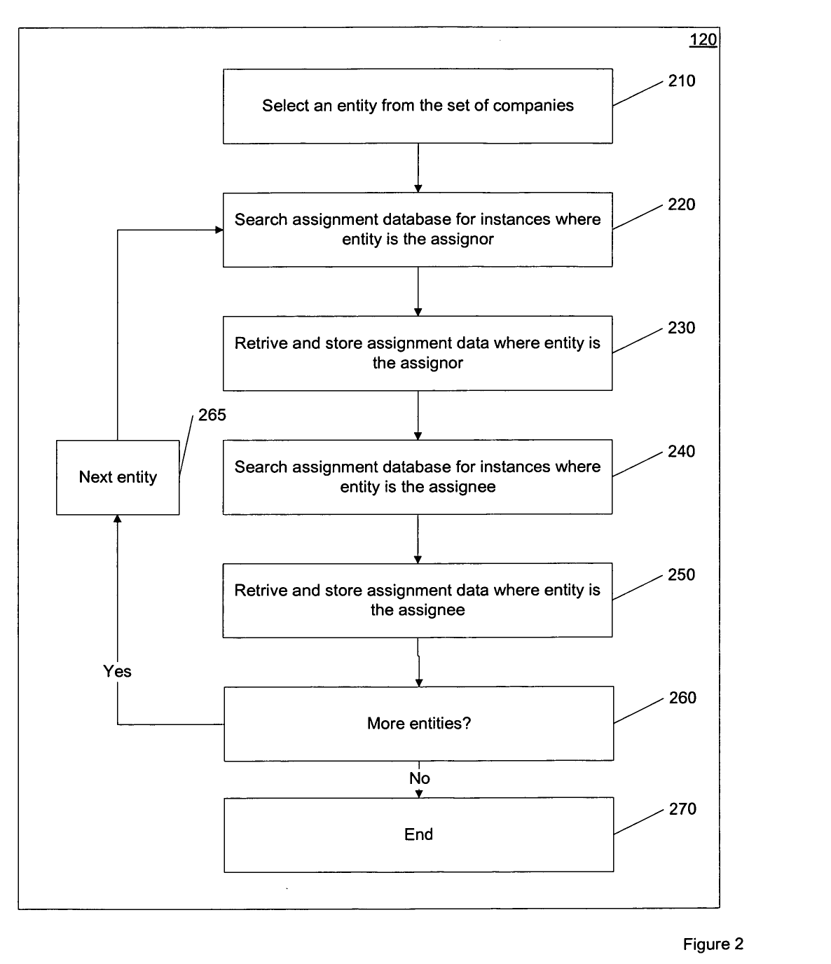

FIG. 2 is a flow-chart of a method of retrieving assignment data (stage 120) consistent with the present invention. A first entity is selected from the set of companies (stage 210). The assignment database is searched for assignment records having the selected entity as the assignor (stage 220). Where a match is found, the assignment record is retrieved and stored in the retrieved patent database (stage 230). Next, the assignment database is searched for assignment records having the selected entity as the assignee (stage 240). Where a match is found, the assignment record is retrieved and stored in the retrieved patent database (stage 250). If more entities are in the set of companies (stage 260), then the next entity is selected (stage 265) and the search process continues (stage 220). If not, the retrieve assignment data stage is complete (stage 270).

FIGS. 3a-c illustrate graphical displays of assignment data consistent with the present invention. FIG. 3a illustrates a table stored in retrieved patent database 470 that is a result of an exemplary search for assignment records for entities A, B, C, and E. The result of the exemplary search yielded nine patents or published patent applications with patent identifiers P1-P9. Each row in the table of 3a illustrates any assignments of the retrieved patents where A, B, C, D, or E was an assignor or an assignee. Note that an entity D appears in the table because an assignment was made from entity B to entity D. Based on the table in FIG. 3a, FIGS. 3b and 3c may be graphically displayed to a user.

FIG. 3b illustrates a table comprising a matrix of assignors and assignees. Each entry in the matrix lists the number of assignments from the corresponding assignor to the corresponding assignee. For example, the table in FIG. 3b illustrates that Company E assigned 4 patents to company A. It also illustrates that company A has acquired a total of five patents and thus may have been in a acquisition mode at some point in time.

FIG. 3c illustrates a table comprising a matrix of assignors and assignees. Each entry in the matrix lists the patent identifiers assigned from the corresponding assignor to the corresponding assignee. For example, the table in FIG. 3b illustrates that Company E assigned patents P5, P6, P7, and P8 to company A. These tables are exemplary only. After understanding this disclosure, those skilled in the art will appreciate that other graphical displays are possible. For example, displays by assignment date or by classification may be created.

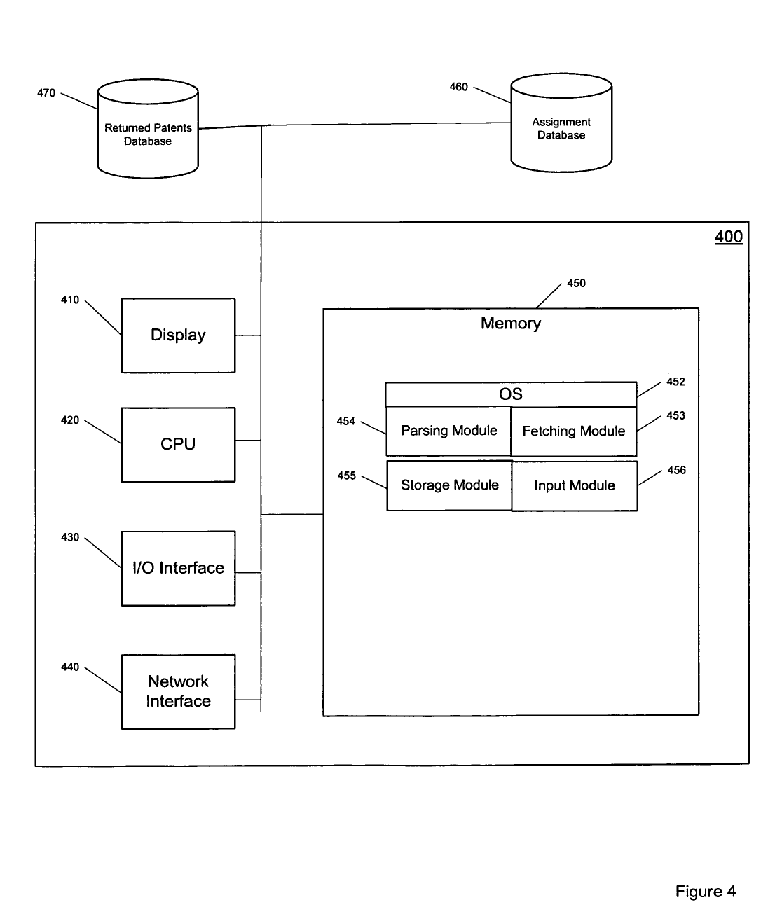

FIG. 4 is a block diagram of a patent flow platform 400 consistent with the present invention. As illustrated in FIG. 4, a system environment of patent flow platform 400 may include a display 410, a central processing unit 420, an input/output interface 430, a network interface 440, and memory 450 coupled together by a bus. Patent flow platform 400 may be adapted to include the functionality and computing capabilities to analyze patent flow from or to entities in a set of companies.

As shown in FIG. 4, patent flow platform 400 may comprise a PC or mainframe computer for performing various functions and operations consistent with the invention. Patent flow platform 400 may be implemented, for example, by a general purpose computer selectively activated or reconfigured by a computer program stored in the computer, or may be a specially constructed computing platform for carrying-out the features and operations of the present invention. Patent flow platform 400 may also be implemented or provided with a wide variety of components or subsystems including, for example, at least one of the following: at least one central processing units 420, a co-processor, memory 450, registers, and other data processing devices and subsystems.

Patent flow platform 400 may also communicate or transfer patent information, assignment database, or returned patent database information via I/O interface 430 and/or network interface 440 through the use of direct connections or communication links to other elements of the present invention. For example, a firewall in network interface 440, prevents access to the platform by unauthorized outside sources.

Alternatively, communication within patent flow platform 400 may be achieved through the use of a network architecture (not shown). In an alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, patent flow platform 400 may be located in the same location or at a geographically distant location from assignment database 460 and returned patent database 470.

I/O interface 430 of the system environment shown in FIG. 4 may be implemented with a wide variety of devices to receive and/or provide the data to and from patent flow platform 400. I/O interface 430 may include an input device, a storage device, and/or a network. The input device may include a keyboard, a microphone, a mouse, a disk drive, video camera, magnetic card reader, or any other suitable input device for providing data to patent flow platform 400.

Network interface 440 may be connected to a network, such as a Wide Area Network, a Local Area Network, or the Internet for providing read/write access to data in assignment database 460 and returned patent database 470.

Memory 450 may be implemented with various forms of memory or storage devices, such as read-only memory (ROM) devices and random access memory (RAM) devices. Memory 450 may also include a memory tape or disk drive for reading and providing records on a storage tape or disk as input to patent flow platform 400. Memory 450 may comprise computer instructions forming: an operating system 452; a parsing module 454 for parsing queries to and from HTML; a fetching module 453 for retrieving assignment records from assignment database 460 and for retrieving patent data from a patent database (not shown); a storage module 455 for storing retrieved assignment records and patent data to retrieved patent database 470; and an input module 456 for receiving the set of companies.

Assignment database 460 is coupled to patent flow platform 400. Assignment database 460 may be, for example, located on servers at the U.S.P.T.O. (USPTO assignment records database or P.A.I.R.) or the E.P.O. (espacenet). Library database 460 may be electronic memory, magnetic memory, optical memory, or a combination thereof, for example, SDRAM, DDRAM, RAMBUS RAM, ROM, Flash memory, hard drives, floppy drives, optical storage drives, or tape drives. Library database 460 may comprise a single device, multiple devices, or multiple devices of multiple device types, for example, a combination of ROM and a hard drive.

Retrieved patent database 470 is coupled to patent flow platform 400. A database of tables having assignment records and patent data may be stored in retrieved patent database 470. Retrieved patent database 470 may comprise, for example, a spreadsheet as well as a traditional database. Retrieved patent database 470 may also be stored in memory 450, and not as an external database. Retrieved patent database 470 may be electronic memory, magnetic memory, optical memory, or a combination thereof, for example, SDRAM, DDRAM, RAMBUS RAM, ROM, Flash memory, hard drives, floppy drives, optical storage drives, or tape drives. Retrieved patent database 470 may comprise a single device, multiple devices, or multiple devices of multiple device types, for example, a combination of ROM and a hard drive.

Those skilled in the art will appreciate that all or part of systems and methods consistent with the present invention may be stored on or read from other computer-readable media, such as: secondary storage devices, like hard disks, floppy disks, flash storages, CD, or DVD; a carrier wave received from the Internet; or other forms of computer-readable memory, such as read-only memory (ROM), random-access memory (RAM), or magnetic RAM.

Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

We claim:

1. A method for analyzing patent flow, the method comprising:
receiving a company set including an entity name;
retrieving assignment data for the entity name, where the assignment data includes at least one assignment record having an assignor, an assignee, and a patent identifier associated with the assigner and the assignee, and where the entity name matches either the assignor or the assignee;
storing the retrieved assignment data; and
graphically displaying the relationship between each retrieved assignor and assignee in the assignment data.

2. The method of claim 1, wherein retrieving assignment data comprises retrieving every assignment record where the entity name matches an assignor in the assignment database.

3. The method of claim 1, wherein retrieving assignment data comprises retrieving every assignment record where the entity name matches an assignee in the assignment database.

4. The method of claim 1, further comprising retrieving patent data associated with the patent identifier from a patent database.

5. The method of claim 1, wherein graphically displaying the relationship between each retrieved assignor and assignee in the assignment data further comprises displaying a table having a matrix of each assignee and each assignor and wherein the table lists an ordinal number of assignments from each assignor to each assignee.

6. The method of claim 1, wherein graphically displaying the relationship between each retrieved assignor and assignee in the assignment data further comprises displaying a table having a matrix of each assignee and each assignor and wherein the table lists each patent identifier assigned from each assignor to each assignee.

7. The method of claim 4, wherein graphically displaying the relationship between each retrieved assignor and assignee in the assignment data further comprises:
receiving a patent classification; and
only graphically displaying the relationship for each assignment record with a patent identifier having patent data matching the received patent classification.

8. A system for analyzing patent flow, comprising:
a memory;
a processor coupled to the memory, the processor operable to:
receive a company set including an entity name;
retrieve assignment data for the entity name, where the assignment data includes at least one assignment record having an assignor, an assignee, and a patent identifier associated with the assigner and the assignee, and where the entity name matches either the assignor or the assignee;
store the retrieved assignment data; and
graphically display the relationship between each retrieved assignor and assignee in the assignment data.

9. The system of claim 8, the processor further operable to retrieve every assignment record where the entity name matches an assignor in the assignment database.

10. The system of claim 8, the processor further operable to retrieve every assignment record where the entity name matches an assignee in the assignment database.

11. The system of claim 8, the processor further operable to retrieve patent data associated with the patent identifier from a patent database.

12. The system of claim 8, the processor further operable to display a table having a matrix of each assignee and each assignor and wherein the table lists an ordinal number of assignments from each assignor to each assignee.

13. The system of claim 8, the processor further operable to display a table having a matrix of each assignee and each assignor and wherein the table lists each patent identifier assigned from each assignor to each assignee.

14. The system of claim 11, the processor further operable to:
receive a patent classification; and
limit the graphical display of the relationship for each assignment record to those assignment records having a patent identifier having patent data matching the received patent classification.
